(19) United States
(12) Patent Application Publication
(10) Pub. No.: US 2024/0181919 A1
(43) Pub. Date: Jun. 6, 2024

(54) Battery Replacement Apparatus and Method

(71) Applicant: TOYOTA JIDOSHA KABUSHIKI KAISHA, Toyota-shi Aichi-ken (JP)

(72) Inventors: Mamoru SAITO, Toyota-shi Aichi-ken (JP); Shin Inoue, Okazaki-shi Aichi-ken (JP); Naoki Takahashi, Miyoshi-shi Aichi-ken (JP)

(73) Assignee: TOYOTA JIDOSHA KABUSHIKI KAISHA, Toyota-shi Aichi-ken (JP)

(21) Appl. No.: 18/512,866

(22) Filed: Nov. 17, 2023

(30) Foreign Application Priority Data
Dec. 5, 2022 (JP) 2022-194387

(51) Int. Cl. B60L 53/80; B66F 11/00; H01M 50/244; H01M 50/249

(52) U.S. Cl. CPC B60L 53/80; B66F 11/00; H01M 50/244; H01M 50/249; H01M 2220/20

(57) ABSTRACT

A battery replacement apparatus includes: a battery replacement station including a floor on which an electrically powered vehicle can be stopped; a battery mounting table on which the first battery and the second battery can be mounted and which is movable below the electrically powered vehicle in a vertical direction; and a raising and lowering unit movable below the electrically powered vehicle in the vertical direction independently of the battery mounting table. The raising and lowering unit is movable between a raised position to which at least a part of the electrically powered vehicle has been moved upward from the floor, and a separated position separated downward from the electrically powered vehicle. The battery mounting table is capable of moving up to a position where the battery mounting table contacts a bottom surface of the first battery when the raising and lowering unit is located at the raised position.

This nonprovisional application is based on Japanese Patent Application No. 2022-194387 filed on Dec. 5, 2022 with the Japan Patent Office, the entire contents of which are hereby incorporated by reference.

### BACKGROUND

### Field

The present disclosure relates to a battery replacement apparatus and a battery replacement method.

### Description of the Background Art

Japanese Patent Application Laid-Open No. 2012-192783 discloses a battery replacement apparatus that replaces a battery mounted on an electrically powered vehicle with a charged battery. The battery replacement apparatus includes a battery mounting portion movable in a vertical direction below the battery electric vehicle, a pair of vehicle lifting members fixed to an upper surface of the battery mounting portion, and a battery raising and lowering unit which is movable up and down with respect to the battery mounting portion. The pair of vehicle lifting members is disposed at both end portions of the battery mounting portion in the vehicle width direction. The battery raising and lowering unit is disposed at a central portion of the battery mounting portion.

At the time of battery replacement by the battery replacement apparatus, first, the battery mounting portion and the vehicle lifting member are raised toward the battery attached to the lower portion of the battery electric vehicle, whereby the vehicle lifting member comes into contact with the lower surface of the under-reinforcement of the battery electric vehicle. Then, the battery mounting portion and the vehicle lifting member raise the battery electric vehicle until the battery electric vehicle becomes horizontal. In this state, a gap is formed between the lower surface of the battery attached to the battery electric vehicle and the upper surface of the battery mounting portion. When the battery is detached in this state, the battery falls toward the battery mounting portion by an amount corresponding to the gap. In order to avoid this, in the battery replacement apparatus, next, the battery raising and lowering unit is driven to project and contact the lower surface of the battery. After the battery is detached, the battery raising and lowering unit is driven to retract. Thus, the battery is placed on the battery mounting portion.

### SUMMARY

In the battery replacement apparatus described in Japanese Patent Application Laid-Open No. 2012-192783, when the electrically powered vehicle is lifted by the pair of vehicle lifting members, the weight of the electrically powered vehicle is also applied to the battery mounting portion, so that there is a concern that deformation such as bending of the battery mounting portion may occur due to repeated battery replacement. Then, the battery raising and lowering unit supports the battery in an unstable manner.

It is an object of the present disclosure to provide a battery replacement apparatus and a battery replacement method capable of suppressing deformation of a battery mounting table.

A battery replacement apparatus according to one aspect of the present disclosure is a battery replacement apparatus for replacing a used first battery attached to a vehicle body of an electrically powered vehicle with a charged second battery, and the battery replacement apparatus includes: a battery replacement station including a floor on which the electrically powered vehicle can be stopped, and in which removal of the first battery from the vehicle body and attachment of the second battery to the vehicle body are performed; a battery mounting table on which the first battery and the second battery can be mounted, the battery mounting table being movable below the electrically powered vehicle in a vertical direction; and a raising and lowering unit movable below the electrically powered vehicle in the vertical direction independently of the battery mounting table, wherein the raising and lowering unit is movable between a raised position to which at least a part of the electrically powered vehicle has been moved upward from the floor, and a separated position separated downward from the electrically powered vehicle, and the battery mounting table is capable of moving up to a position where the battery mounting table contacts a bottom surface of the first battery when the raising and lowering unit is located at the raised position.

A battery replacement method according to one aspect of the present disclosure is a battery replacement method for replacing a used first battery attached to a vehicle body of an electrically powered vehicle with a charged second battery, and the battery replacement method includes: a lifting step of lifting the electrically powered vehicle by a raising and lowering unit, such that at least a part of the electrically powered vehicle is moved upward from a floor, the raising and lowering unit being capable of moving below the electrically powered vehicle in a vertical direction; a raising step of raising a battery mounting table, such that the battery mounting table contacts a bottom surface of the first battery in a state where the electrically powered vehicle is lifted by the raising and lowering unit, the battery mounting table being capable of moving in the vertical direction independently of the raising and lowering unit; and a removing step of removing the first battery from the vehicle body in a state in which the battery mounting table contacts the bottom surface of the first battery.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 schematically shows a battery replacement apparatus according to an embodiment of the present disclosure.

FIG. 2 is a plan view showing a vehicle stop area in the battery replacement apparatus.

FIG. 3 is a diagram schematically showing a configuration of a battery mounting table and a raising and lowering unit.

FIG. 4 is a perspective view schematically showing a configuration of a battery mounting table and a raising and lowering unit.

FIG. 5 is a bottom view of the electrically powered vehicle.

FIG. 6 is a flowchart showing each step of the battery replacement apparatus.

FIG. 7 is a cross-sectional view schematically showing a state before the battery mounting table and the electrically powered vehicle are positioned with respect to each other.

FIG. 8 is a cross-sectional view schematically showing a state in which the battery mounting table and the electrically powered vehicle are positioned with respect to each other.

FIG. 9 is a cross-sectional view schematically showing a modified example of the positioning pin and the marker.

FIG. 10 is a cross-sectional view schematically showing a modified example of the positioning pin and the marker.

FIG. 11 is a cross-sectional view schematically showing a modified example of the positioning pin and the marker.

### DESCRIPTION OF THE EMBODIMENTS

Hereinafter, embodiments of the present disclosure will be described in detail with reference to the accompanying drawings. In the drawings, the same or corresponding parts are denoted by the same reference numerals, and the description thereof will not be repeated.

### (Configuration of Battery Replacement Apparatus)

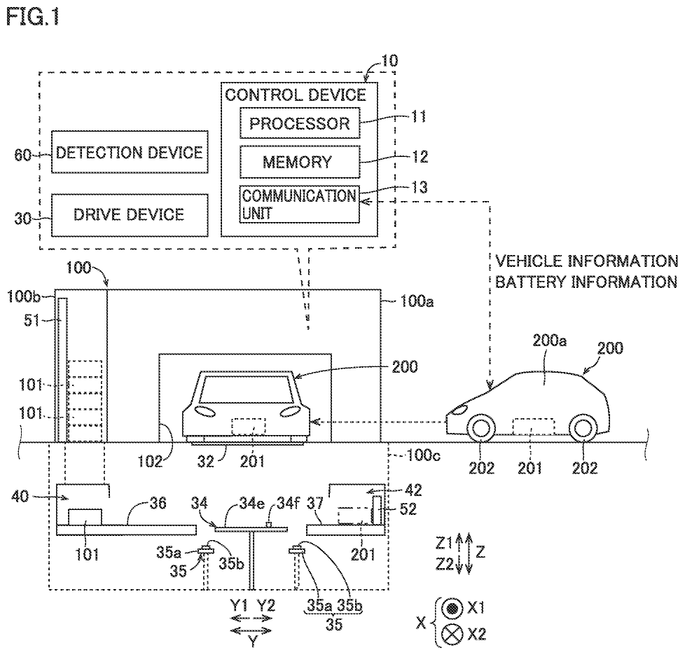

FIG. 1 is a diagram showing a battery replacement apparatus 100 and an electrically powered vehicle 200 according to the present embodiment. The battery replacement apparatus 100 is an apparatus for replacing a battery (used battery) 201 attached to the electrically powered vehicle 200 with a charged battery (new battery) 101. The battery 201 and the battery 101 are examples of the “first battery” and the “second battery” of the present disclosure, respectively. The battery replacement apparatus 100 includes a battery replacement station 100a, a storage 100b, and an underfloor area 100c.

The battery replacement station 100a is a station in which the battery 201 is detached from the electrically powered vehicle 200 and the battery 101 is attached to the electrically powered vehicle 200. The battery replacement station 100a is provided with an entrance/exit 102 for the electrically powered vehicle 200 to enter/exit.

The storage 100b stores the charged battery 101. The storage 100b is provided in parallel with the battery replacement station 100a. A charging facility 51 capable of charging the battery 201 removed from the electrically powered vehicle 200 is provided in the storage 100b. The battery 201 is charged by the charging facility 51 in the storage 100b. The battery 101 charged in the storage 100b, that is, the charged battery 101 is moved to the temporary placement site 40 provided in the underfloor area 100c, and then conveyed to the electrically powered vehicle 200.

The underfloor area 100c is provided below the battery replacement station 100a and the storage 100b. The underfloor area 100c is provided with a battery mounting table 34, a raising and lowering unit 35, a first transport unit 36, and a second transport unit 37, which will be described later.

The battery replacement apparatus 100 includes a control device 10, a drive device 30, and a detection device 60.

The control device 10 includes a processor 11, a memory 12, and a communication unit 13. The memory 12 stores, in addition to a program executed by the processor 11, information (e.g., map, formula, and various parameters) used by the program. As will be described in detail later, the processor 11 controls the drive device 30 and the detection device 60.

The communication unit 13 includes various communication I/Fs. The processor 11 controls the communication unit 13. The communication unit 13 communicates with a DCM or the like of the electrically powered vehicle 200. The communication unit 13 and the electrically powered vehicle 200 can perform bidirectional communication. The communication unit 13 may communicate with a mobile terminal or the like possessed by the user of the electrically powered vehicle 200.

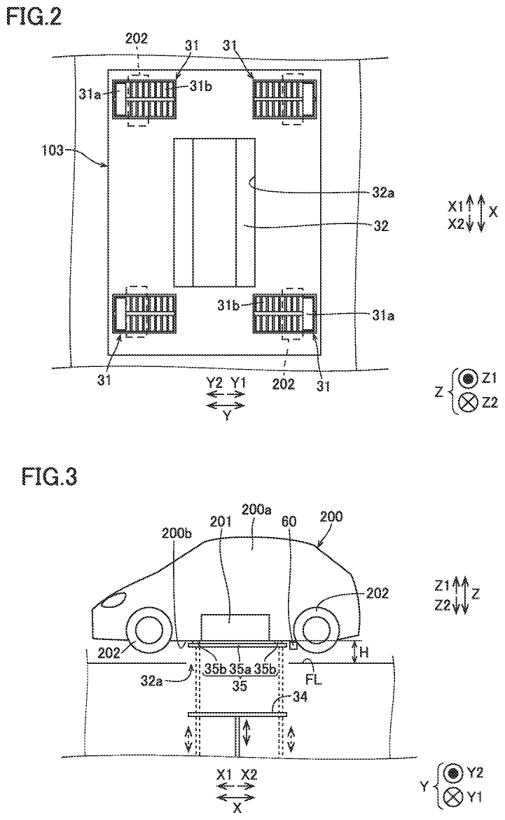

As shown in FIG. 2, the battery replacement apparatus 100 is provided with a vehicle stop area 103. In a state in which the electrically powered vehicle 200 is stopped in the vehicle stop area 103, when the user performs an operation for instructing the start of the battery replacement operation in a navigation system (not shown) of the electrically powered vehicle 200, the communication unit 13 receives an instruction signal for starting the battery replacement operation from the electrically powered vehicle 200. The processor 11 starts the control of the battery replacement operation based on the reception of the instruction signal by the communication unit 13. The electrically powered vehicle 200 stops in the vehicle stop area 103 such that the front-rear direction is the X direction and the left-right direction is the Y direction.

The drive device 30 includes a wheel chock 31 (see FIG. 2), a shutter 32 (see FIG. 2), a battery mounting table 34 (see FIG. 1), a raising and lowering unit 35 (see FIG. 1), a first transport unit 36 (see FIG. 1), and a second transport unit 37 (see FIG. 1).

Referring again to FIG. 2, in vehicle stop area 103, four wheel chocks 31 are provided. The wheel chocks 31 are provided so as to correspond to the four wheels 202 of the electrically powered vehicle 200.

The wheel chock 31 includes a pressing member 31a and a lateral roller portion 31b. The pressing member 31a moves the wheel 202 by pressing the wheel 202 from the outside (side). The pressing member 31a is disposed so as to straddle the lateral roller portion 31b. As a result, the wheel 202 is positioned by the wheel chock 31.

The lateral roller portion 31b includes a plurality of rollers whose rotation axes extend in the X direction. The plurality of rollers of the lateral roller portion 31b are arranged in the Y direction. By the rotation of the plurality of rollers of the lateral roller portion 31b, the pressing member 31a is moved along the Y direction.

As shown in FIG. 2, the shutter 32 is provided in the vehicle stop area 103. The shutter 32 is configured to be able to open and close an opening 32a formed in the floor FL of the vehicle stop area 103. The shutter 32 can be switched between an open state in which the opening 32a is opened and a closed state in which the opening 32a is closed.

The raising and lowering unit 35 is movable in the vertical direction between a position higher than the floor FL and a position lower than the floor FL through the opening 32a. As shown in FIG. 3, the raising and lowering unit 35 can lift the electrically powered vehicle 200 while holding the electrically powered vehicle 200 from below so that the wheels 202 of the electrically powered vehicle 200 float from the floor FL. The raising and lowering unit 35 raises the electrically powered vehicle so that the height H of the lower surface 200b of the vehicle body 200a from the floor FL becomes a predetermined height. The raising and lowering unit 35 is movable between a raised position in which at least a part of the electrically powered vehicle 200 is moved upward from the floor FL and a separated position separated downward from the electrically powered vehicle 200. The raised position may be set at a position where the wheels 202 of the electrically powered vehicle 200 float upward from the floor FL.

The raising and lowering unit 35 includes a pair of elevation bars 35a arranged at intervals in a direction (Y direction) orthogonal to the vertical direction. Each of the pair of elevation bars 35a is provided with two protrusions 35b protruding upward. The electrically powered vehicle 200 is supported from below by two protrusions 35b (i.e., four protrusions 35b) of each of the pair of elevation bars 35a.

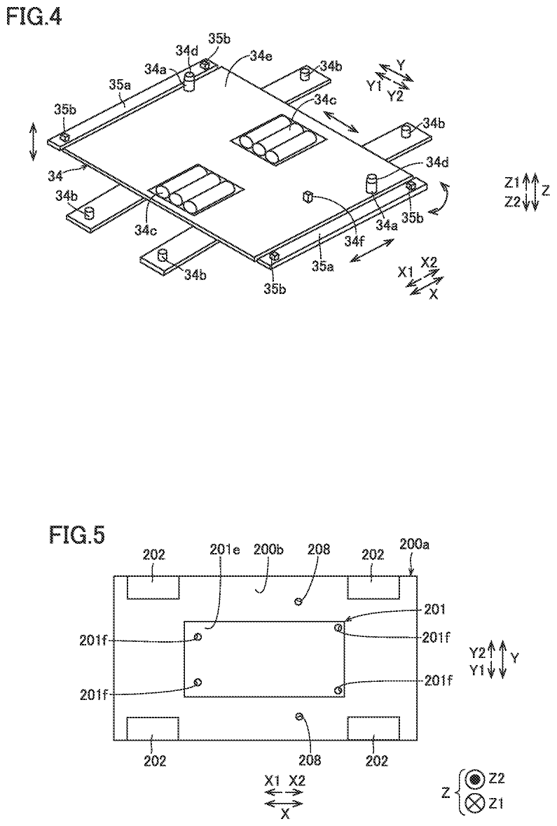

The battery mounting table 34 is disposed below the battery replacement station 100a, more specifically, below the opening 32a. The battery mounting table 34 can mount the batteries 101 and 201 and can move in the vertical direction. The battery mounting table 34 is movable in the vertical direction independently of the raising and lowering unit 35. As shown in FIG. 4, the battery mounting table 34 includes a base portion 34e, two positioning pins 34a, four locking/unlocking tools 34b, a roller portion 34c, and a stopper 34f.

The base portion 34e is disposed between the pair of elevation bars 35a. The base portion 34e is movable in the vertical direction. The base portion 34e is formed in a flat plate shape. The base portion 34e has an outer shape larger than the outer shape of the batteries 101 and 201. The base portion 34e is configured to be movable in the horizontal direction below the electrically powered vehicle 200. Specifically, the base portion 34e is movable in the X direction (X1 direction, X2 direction) and the Y direction (Y1 direction, Y2 direction). The base portion 34e is rotatable so as to change the direction (angle) in the XY plane. Each of the pair of elevation bars 35a may be movable similarly to the base portion 34e.

Each positioning pin 34a is provided on the base portion 34e. Each positioning pin 34a is a portion for positioning the vehicle body 200a of the electrically powered vehicle 200 and the base portion 34e. One positioning pin 34a is provided at one end of the base portion 34e in a direction (Y direction) parallel to the vehicle width direction. The other positioning pin 34a is provided at the other end of the base portion 34e in a direction (Y direction) parallel to the vehicle width direction.

As shown in FIG. 5, the vehicle body 200a of the electrically powered vehicle 200 has a lower surface 200b, and the lower surface 200b is provided with pin insertion holes 208 into which the positioning pins 34a are inserted. Each positioning pin 34a can be inserted into a pin insertion hole.

Each locking/unlocking tool 34b is movable in the vertical direction. Each locking/unlocking tool 34b is movable in the vertical direction with respect to the base portion 34e. As shown in FIG. 4, each locking/unlocking tool 34b is disposed inside the pair of positioning pins 34a in the Y direction. Each locking/unlocking tool 34b is disposed outside the base portion 34e in the X direction.

As shown in FIG. 5, the battery 201 has a bottom surface 201e, and tool insertion holes 201f into which the respective locking/unlocking tools 34b are inserted are formed in the bottom surface 201e. A tool insertion hole is also formed in the bottom surface of the battery 101. Each locking/unlocking tool 34b can be inserted into the tool insertion hole 201f.

The roller portion 34c is provided on the base portion 34e. The roller portion 34c is rotatable around a rotation axis extending in the X direction. When the roller portion 34c rotates in one direction, the batteries 101 and 201 relatively move toward one side (for example, the Y1 side) in the Y direction with respect to the base portion 34e, and when the roller portion 34c rotates in the other direction, the batteries 101 and 201 relatively move toward the other side in the Y direction with respect to the base portion 34e.

The marker 34d is provided at the upper end of each positioning pin 34a. In some embodiments, the marker 34d irradiates light at least in the horizontal direction. The marker 34d may be a light emitter such as an LED. The marker 34d may be tapered upward.

The stopper 34f is provided on the base portion 34e. The stopper 34f will be described later.

Referring again to FIG. 1, the first transport unit 36 transports the battery 101 stored in the storage 100b toward the battery mounting table 34. Specifically, in the underfloor area 100c, a temporary placement site 40 for temporarily placing the charged battery 101 stored in the storage 100b is provided, and the first transport unit 36 can transport the battery 101 from the temporary placement site 40 toward the battery mounting table 34. The first transport unit 36 may be of a belt conveyor type, for example.

The second transport unit 37 conveys the battery 201 after use, which is detached from the electrically powered vehicle 200 and mounted on the battery mounting table 34, from the battery mounting table 34. Specifically, in the underfloor area 100c, a storage space 42 for storing the battery 201 is provided at a position separated from the storage 100b, and the second transport unit 37 transports the battery 201 from the battery mounting table 34 toward the storage space 42 along a transport direction (Y2 direction) in which the first transport unit 36 transports the battery 101 toward the battery mounting table 34. The first transport unit 36 and the second transport unit 37 are arranged in a straight line. The second transport unit 37 may also be of a belt conveyor type, for example.

A charging facility 52 capable of charging the battery 201 is provided in the storage space 42. The battery 201 stored in the storage space 42 is transported to the storage 100b by a transport unit (not shown) after the charging by the charging facility 52 is completed or during the charging. The conveying unit may include a first transport unit 36 and a second transport unit 37.

Here, the stopper 34f will be described. The stopper 34f is provided at a downstream portion of the roller portion 34c in the conveying direction (Y2 direction) of the base portion 34e. The stopper 34f contacts the battery 101 conveyed from the first transport unit 36 to the base portion 34e from a direction opposite to the conveying direction. The position of the stopper 34f in the direction (Y direction) parallel to the conveyance direction is set based on the position of the battery 201 mounted on the electrically powered vehicle 200. The stopper 34f is movable in the vertical direction between a protruding position (a position shown in FIG. 4) where the stopper 34f protrudes upward from the base portion 34e so as to abut on the batteries 101 and 201, and a buried position where the stopper 34f is buried in the base portion 34e so as to allow movement of the battery 201 from the base portion 34e to the second transport unit 37 after use.

The movement of the stopper 34f between the protruding position and the buried position is controlled by the processor 11 of the control device 10. The processor 11 positions the stopper 34f at the protruding position when the charged battery 101 moves from the first transport unit 36 to the base portion 34e, and positions the stopper 34f at the buried position when the used battery 201 moves from the base portion 34e to the second transport unit 37.

The detection device 60 can detect the position of the marker 34d. In the present embodiment, the detection device 60 can detect light emitted from the marker 34d. The detection device 60 includes, for example, a camera. As shown in FIG. 3, the detection device 60 is provided below the electrically powered vehicle 200 stopped in the vehicle stop area 103. The detection signal from the detection device 60 is sent to the communication unit 13 of the control device 10.

The processor 11 of the control device 10 determines that the positioning pin 34a has been inserted into the pin insertion hole 208 when the marker 34d is not detected by the detection device 60, more specifically, when the light emitted from the marker 34d is not detected. In other words, the processor 11 determines that the battery mounting table 34 has been positioned with respect to the batteries 101 and 201 when the detection device 60 stops detecting the light emitted from the marker 34d.

### Battery Replacement Method

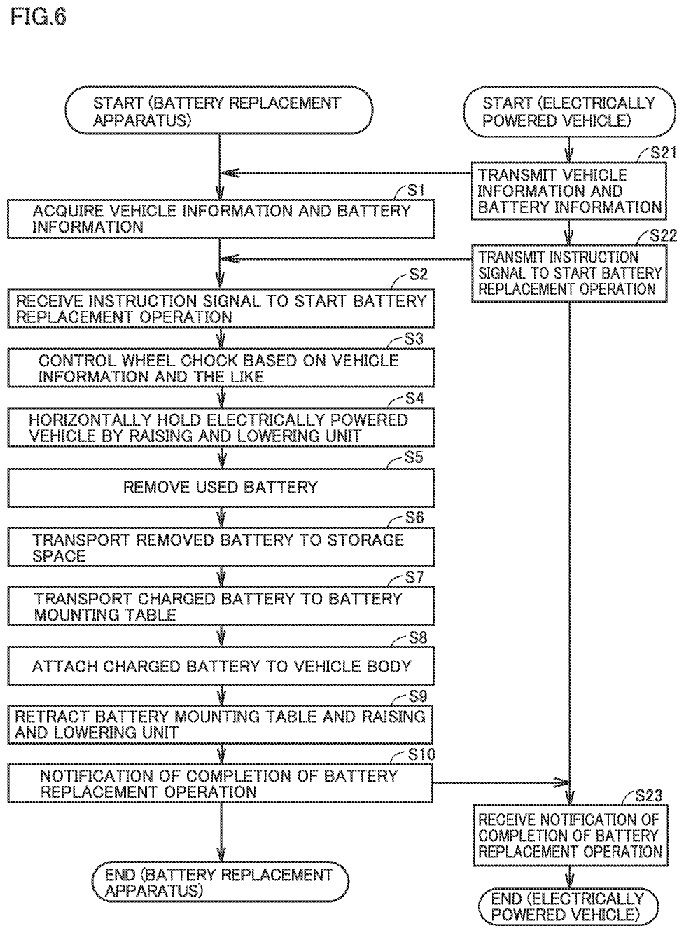

Next, a battery replacement method using the battery replacement apparatus 100 will be described with reference to a flowchart (sequence diagram) of FIG. 6.

### [Transmission of Vehicle Information and the Like: Electrically Powered Vehicle]

First, in step S21, the electrically powered vehicle 200 transmits information about the electrically powered vehicle 200 and information about the battery 201 to the communication unit 13 of the battery replacement apparatus 100. For example, when an operation of transmitting the above information is performed in a navigation system (not shown) of the electrically powered vehicle 200, the above information is transmitted to the communication unit 13. The electrically powered vehicle 200 transmits the above information before entering the battery replacement apparatus 100. The above information may be transmitted after the electrically powered vehicle 200 has entered the battery replacement apparatus 100.

### [Acquisition of Vehicle Information and the Like: Battery Replacement Apparatus]

Next, in step S1, the communication unit 13 of the battery replacement apparatus 100 acquires information about the electrically powered vehicle 200 and information about the battery 201 transmitted from the electrically powered vehicle 200 in step S21 by communication. The acquired information is stored in the memory 12 (see FIG. 1).

The communication unit 13 also controls the capacity (charge capacity) of the battery 201 and the SOC (State Of) of the battery 201.

Information of Charge) may be acquired.

### [Transmission of an Instruction Signal for Battery Replacement Work: Electrically Powered Vehicle]

Next, in step S22, the electrically powered vehicle 200 stopped in the vehicle stop area 103 transmits an instruction signal for starting the battery replacement operation to the communication unit 13.

### [Receiving an Instruction Signal for a Battery Replacement Operation: Battery Replacement Apparatus]

Next, in step S2, the communication unit 13 receives the instruction signal transmitted from the electrically powered vehicle 200 in step S22. In step S2, after receiving the instruction signal, the processor 11 may transmit an instruction message or the like for turning off the ignition power supply to the user of the electrically powered vehicle 200 through the communication unit 13.

### [Control of Wheel Choke: Battery Replacement Apparatus]

Next, in step S3, the processor 11 adjusts the position of the wheel chock 31 (see FIG. 2) based on the information (vehicle information and battery information) acquired through the communication unit 13 in step S1. Note that the processor 11 may control each of the four wheel chocks 31 independently of each other.

Thus, the position and orientation of the vehicle body 200a in the horizontal direction are adjusted, and the position and orientation of the battery 201 in the horizontal direction are adjusted. As a result, the battery 201 is moved to a predetermined position above the opening 32a.

### [Holding the Vehicle Body Horizontally: Battery Replacement Apparatus]

Next, in step S4, the processor 11 raises the raising and lowering unit 35 in a state where the shutter 32 is in the open state and the shutter 32 is in the open state. Thus, after passing through the opening 32a, the raising and lowering unit 35 lifts up the electrically powered vehicle 200 so that at least a part of the electrically powered vehicle 200 moves upward from the floor FL (the lifting step). Specifically, the raising and lowering unit 35 lifts the electrically powered vehicle 200 such that the height H (see FIG. 3) of the lower surface 200b of the vehicle body 200a from the floor FL becomes a predetermined height.

[Removal of the Battery after Use: Battery Replacement Apparatus]

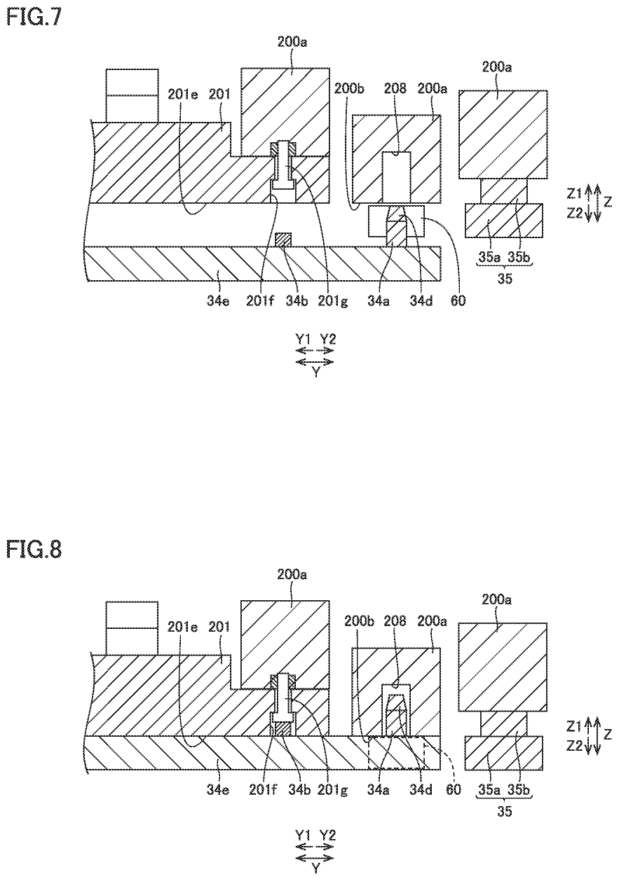

Next, in step S5, the battery 201 after use is detached from the vehicle body 200a of the electrically powered vehicle 200. First, the processor 11 raises the battery mounting table 34. At this time, as shown in FIG. 7, the detection device 60 continues to detect the light emitted from the marker 34d. While the detection device 60 is detecting light from the marker 34d, the processor 11 determines that the positioning pin 34a is not inserted into the pin insertion hole 208.

When the battery mounting table 34 further rises, as shown in FIG. 8, the positioning pin 34a is inserted into the pin insertion hole 208 formed in the lower surface 200b of the vehicle body 200a, the locking/unlocking tool 34b is inserted into the tool insertion hole 201f formed in the bottom surface 201e of the battery 201, and the base portion 34e comes into contact with or approaches the bottom surface 201e of the battery 201 (elevation stroke). As a result, the battery mounting table 34 is positioned with respect to the electrically powered vehicle 200 (battery 201). During the raising step, the marker 34d is inserted into the pin insertion hole 208, so that the detection device 60 does not detect the light emitted from the marker 34d. At this time, the processor 11 determines that the positioning pin 34a has been inserted into the pin insertion hole 208. At this time, the positioning pin 34a is inserted into the pin insertion hole 208 before the locking/unlocking tool 34b is inserted into the tool insertion hole 201f.

In the step of raising the battery mounting table 34, when the detection device 60 continues to detect the marker 34d even though the base portion 34e is raised to the height position where the marker 34d is expected to be inserted into the pin insertion hole 208, the processor 11 determines that the marker 34d is not inserted into the pin insertion hole 208. In this case, after lowering the base portion 34e to such an extent that the marker 34d is separated from the lower surface 200b of the vehicle body 200a, the processor 11 adjusts the position of the base portion 34e with respect to the vehicle body 200a in the X direction and the Y direction, and raises the base portion 34e again.

Next, the processor 11 raises the locking/unlocking tool 34b in a state where the locking/unlocking tool 34b is inserted into the tool insertion hole 201f. Then, the processor 11 drives (rotates) the locking/unlocking tool 34b inserted into the tool insertion hole 201f. Thereby, the bolt 201g in the tool insertion hole 201f is unlocked. As a result, the battery 201 is detached from the vehicle body 200a and mounted on the base portion 34e. The timing at which the positioning pin 34a is inserted into the pin insertion hole 208 and the timing at which the locking/unlocking tool 34b is inserted into the tool insertion hole 201f may be the same.

[Transport the Battery after Use to the Storage Space: Battery Replacement Apparatus]

Next, in step S6, the battery 201 removed from the vehicle body 200a in step S5 is transported to the storage space 42 (see FIG. 1). First, the processor 11 lowers the battery mounting table 34 on which the battery 201 is mounted to the height position of the second transport unit 37 (see FIG. 1). Next, the processor 11 lowers the raising and lowering unit 35 to a position below the battery mounting table 34 (for example, a position shown in FIG. 1). As a result, since the vehicle body 200a is not held by the raising and lowering unit 35, the electrically powered vehicle 200 is placed on the floor FL of the vehicle stop area 103. At this time, the processor 11 positions the stopper 34f at the buried position. Subsequently, the processor 11 drives the roller portion 34c (see FIG. 4) of the battery mounting table 34 so that the battery 201 moves on the base portion 34e in the conveying direction (Y2 direction). Thereby, the battery 201 mounted on the base portion 34e moves on the base portion 34e toward the second transport unit 37 without abutting on the stopper 34f, and moves from the base portion 34e to the second transport unit 37. The battery 201 is transported to and stored in the storage space 42 by the second transport unit 37. The battery 201 may be charged at the charging facility 52 in the storage space 42. The battery 201 is transported to the storage 100b by the transport unit after the charging is completed or during the charging.

### [Transporting the Charged Battery to a Battery Mounting Table: Battery Replacement Apparatus]

Next, in step S7, the processor 11 conveys the charged battery 101 stored in the storage 100b to the battery mounting table 34. Specifically, after the processor 11 conveys the battery 101 from the storage 100b to the temporary placement site 40 in the underfloor area 100c, the processor 11 conveys the battery 101 from the temporary placement site 40 to the battery mounting table 34 by the first transport unit 36 along the conveying direction (Y2 direction). At this time, the processor 11 positions the stopper 34f at the protruding position. When the battery 101 moves from the first transport unit 36 to the base portion 34e, the processor 11 drives the roller portion 34c so that the battery 101 moves on the base portion 34e in the conveying direction. As a result, the battery 101 stops at a predetermined position on the base portion 34e by abutting against the stopper 34f.

### [Mounting of Charged Battery: Battery Replacement Apparatus]

Next, in step S8, the processor 11 performs control to attach the charged battery 101 to the vehicle body 200a. Specifically, the processor 11 raises the raising and lowering unit 35 so that the height H of the lower surface 200b of the vehicle body 200a from the floor FL of the vehicle stop area 103 becomes a predetermined height.

Next, the processor 11 raises the battery mounting table 34. Thereby, the positioning pin 34a is inserted into the pin insertion hole. The control of the battery mounting table 34 by the processor 11 at this time is the same as that in step S5. In this state, the processor 11 raises the locking/unlocking tool 34b. Thereby, the locking/unlocking tool 34b is inserted into the tool insertion hole of the battery 101. Then, the processor 11 drives (rotates) the locking/unlocking tool 34b. Thus, the bolt in the tool insertion hole is locked. When it is detected that all the bolts have been locked, the vehicle side connector and the connector of the battery 101 are locked. As a result, the mounting of the charged battery 101 to the vehicle body 200a is completed.

### [Retraction of the Battery Mounting Table and the Raising and Lowering Unit: Battery Replacement Apparatus]

Next, in step S9, the processor 11 lowers the battery mounting table 34 and the raising and lowering unit 35 and retracts the battery mounting table 34 and the raising and lowering unit 35 from the electrically powered vehicle 200. Thereafter, the processor 11 closes the shutter 32 (see FIG. 2).

### [Notification of Completion of Battery Replacement Work: Battery Replacement Apparatus]

Next, in step S10, the processor 11 notifies the electrically powered vehicle 200 of the completion of the battery replacement operation through the communication unit 13.

### [Receipt of the Battery Replacement Work Completion Notification: Electrically Powered Vehicle]

In step S23, the electrically powered vehicle 200 receives the notification transmitted from the communication unit 13 of the battery replacement apparatus 100 in step S10. Thus, the electrically powered vehicle 200 is brought into a state in which the ignition power supply can be turned on. Thereafter, the process ends.

In the above embodiment, the position of the drive device 30 is adjusted based on the information about each of the electrically powered vehicle 200 and the battery 201, but the present disclosure is not limited thereto. The position of the drive device 30 may be adjusted based on information about either the electrically powered vehicle 200 or the battery 201.

As described above, in the battery replacement apparatus 100 according to the present embodiment, the electrically powered vehicle 200 is lifted from the floor FL by first moving the raising and lowering unit 35 to the raised position to make the electrically powered vehicle 200 horizontal, and then the battery mounting table 34 is lifted to a position where the battery mounting table 34 abuts on the bottom surface 201e of the battery 201, whereby the battery 201 can be removed from the vehicle body 200a without substantially acting on the battery mounting table 34. Accordingly, deformation of the battery mounting table 34 is suppressed.

### First Modified Example

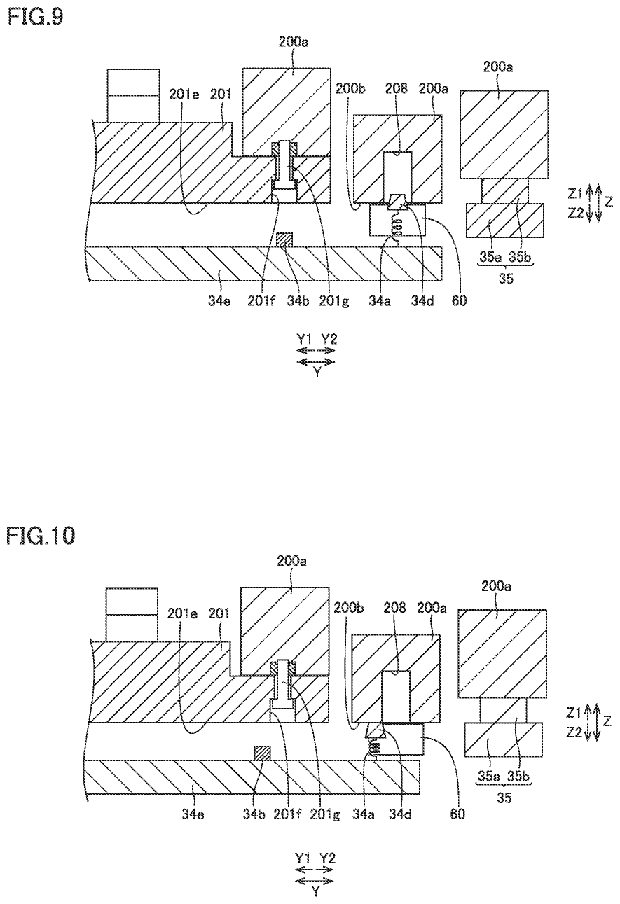

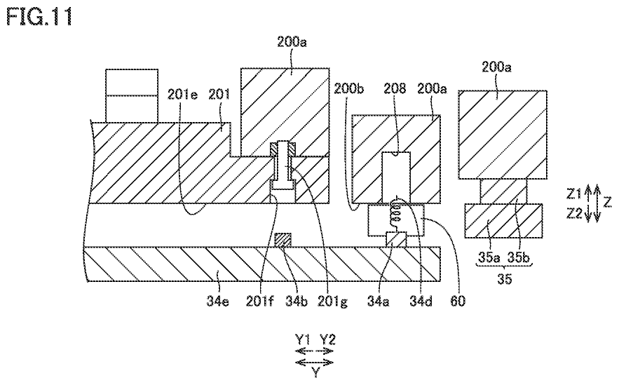

As shown in FIG. 9, the positioning pin 34a may be made of an elastic body capable of compressive deformation. In the example shown in FIG. 9, the positioning pin 34a is formed of a coil spring. In this example, for example, during the control of step S5, when the base portion 34e rises in a state where the marker 34d and the pin insertion hole 208 do not overlap in the height direction (Z direction) as shown in FIG. 10, the positioning pin 34a is compressed and deformed. Therefore, breakage of the marker 34d and the vehicle body 200a is suppressed.

### Second Modified Example

Alternatively, as shown in FIG. 11, the marker 34d may be formed of an elastic body capable of compressive deformation. In the example shown in FIG. 11, the marker 34d is composed of a coil spring. Also in this example, the same effect as in the first modification can be obtained.

In the second modification, the positioning pin 34a may be constituted by a pressure sensor. The pressure sensor sends the detected value to the communication unit 13. In this aspect, the processor 11 determines that the marker 34d is not inserted into the pin insertion hole 208 when the detection value of the pressure sensor becomes equal to or greater than a predetermined value. In this example, the detection device 60 may be omitted.

It will be appreciated by those skilled in the art that the exemplary embodiments described above are specific examples of the aspects described below.

### Aspect 1

A battery replacement apparatus for replacing a used first battery attached to a vehicle body of an electrically powered vehicle with a charged second battery, the battery replacement apparatus comprising:
a battery replacement station including a floor on which the electrically powered vehicle can be stopped, and in which removal of the first battery from the vehicle body and attachment of the second battery to the vehicle body are performed;
a battery mounting table on which the first battery and the second battery can be mounted, the battery mounting table being movable below the electrically powered vehicle in a vertical direction; and
a raising and lowering unit movable below the electrically powered vehicle in the vertical direction independently of the battery mounting table, wherein
the raising and lowering unit is movable between a raised position to which at least a part of the electrically powered vehicle has been moved upward from the floor, and a separated position separated downward from the electrically powered vehicle, and
the battery mounting table is capable of moving up to a position where the battery mounting table contacts a bottom surface of the first battery when the raising and lowering unit is located at the raised position.

In this battery replacement apparatus, the raising and lowering unit is moved first to the raised position to thereby lift the electrically powered vehicle from the floor and hold the electrically powered vehicle horizontally, and the battery mounting table is then raised to the position where it contacts the bottom surface of the first battery, so that the first battery can be removed from the vehicle body while preventing the weight of the electrically powered vehicle from substantially acting on the battery mounting table. Accordingly, deformation of the battery mounting table is suppressed.

### Aspect 2

The battery replacement apparatus according to aspect 1, further comprising:
a control device that controls the battery mounting table and the raising and lowering unit; and
a detection device disposed below the vehicle body, wherein
the battery mounting table includes:
   a base portion which is movable in the vertical direction and on which the first battery and the second battery can be mounted;
   a positioning pin protruding upward from the base portion; and a marker provided at an upper end of the positioning pin,
the vehicle body has a pin insertion hole in which the positioning pin and the marker are to be inserted,
the detection device is capable of detecting the marker, and
the control device determines that the positioning pin is inserted in the pin insertion hole when the marker is no longer detected by the detection device.

In this aspect, based on the fact that the marker is no longer detected by the detection device, the control device can proceed to the next control flow.

### Aspect 3

The battery replacement apparatus according to aspect 2, wherein the positioning pin is formed of an elastic body capable of compressive deformation.

In this aspect, when the base portion is raised in a state where the marker and the pin insertion hole do not overlap each other in the height direction, the positioning pin is compression-deformed, so that breakage of the marker and the vehicle body is suppressed.

### Aspect 4

A battery replacement method for replacing a used first battery attached to a vehicle body of an electrically powered vehicle with a charged second battery, the battery replacement method comprising:
a lifting step of lifting the electrically powered vehicle by a raising and lowering unit, such that at least a part of the electrically powered vehicle is moved upward from a floor, the raising and lowering unit being capable of moving below the electrically powered vehicle in a vertical direction;
a raising step of raising a battery mounting table, such that the battery mounting table contacts a bottom surface of the first battery in a state where the electrically powered vehicle is lifted by the raising and lowering unit, the battery mounting table being capable of moving in the vertical direction independently of the raising and lowering unit; and
a removing step of removing the first battery from the vehicle body in a state in which the battery mounting table contacts the bottom surface of the first battery.

According to this battery replacement method, the weight of the electrically powered vehicle does not substantially act on the battery mounting table during the removal step, and therefore, deformation of the battery mounting table is suppressed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A battery replacement apparatus for replacing a used first battery attached to a vehicle body of an electrically powered vehicle with a charged second battery, the battery replacement apparatus comprising:
a battery replacement station including a floor on which the electrically powered vehicle can be stopped, and in which removal of the first battery from the vehicle body and attachment of the second battery to the vehicle body are performed;
a battery mounting table on which the first battery and the second battery can be mounted, the battery mounting table being movable below the electrically powered vehicle in a vertical direction; and
a raising and lowering unit movable below the electrically powered vehicle in the vertical direction independently of the battery mounting table, wherein
the raising and lowering unit is movable between a raised position to which at least a part of the electrically powered vehicle has been moved upward from the floor, and a separated position separated downward from the electrically powered vehicle, and
the battery mounting table is capable of moving up to a position where the battery mounting table contacts a bottom surface of the first battery when the raising and lowering unit is located at the raised position.

2. The battery replacement apparatus according to claim 1, further comprising:
a control device that controls the battery mounting table and the raising and lowering unit; and
a detection device disposed below the vehicle body, wherein
the battery mounting table includes:
a base portion which is movable in the vertical direction and on which the first battery and the second battery can be mounted;
a positioning pin protruding upward from the base portion; and
a marker provided at an upper end of the positioning pin,
the vehicle body has a pin insertion hole in which the positioning pin and the marker are to be inserted,
the detection device is capable of detecting the marker, and
the control device determines that the positioning pin is inserted in the pin insertion hole when the marker is no longer detected by the detection device.

3. The battery replacement apparatus according to claim 2, wherein the positioning pin is formed of an elastic body capable of compressive deformation.

4. A battery replacement method for replacing a used first battery attached to a vehicle body of an electrically powered vehicle with a charged second battery, the battery replacement method comprising:
a lifting step of lifting the electrically powered vehicle by a raising and lowering unit, such that at least a part of the electrically powered vehicle is moved upward from a floor, the raising and lowering unit being capable of moving below the electrically powered vehicle in a vertical direction;
a raising step of raising a battery mounting table, such that the battery mounting table contacts a bottom surface of the first battery in a state where the electrically powered vehicle is lifted by the raising and lowering unit, the battery mounting table being capable of moving in the vertical direction independently of the raising and lowering unit; and
a removing step of removing the first battery from the vehicle body in a state in which the battery mounting table contacts the bottom surface of the first battery.
